(19) United States
(12) Patent Application Publication
(10) Pub. No.: US 2004/0022708 A1
(43) Pub. Date: Feb. 5, 2004

(54) Selective non-catalytic reduction of NOx

(75) Inventors: Boyd E. Hurst, Humble, TX (US); William J. McLaughlin, Houston, TX (US); David G. Knight, Fairfax, VA (US); Theresa J. Takacs, Alexandria, VA (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(73) Assignee: ExxonMobil Research and Engineering Company, Annandale, NJ

(21) Appl. No.: 10/427,265

(22) Filed: May 1, 2003

Related U.S. Application Data
(60) Provisional application No. 60/386,560, filed on Jun. 5, 2002.
(60) Provisional application No. 60/386,492, filed on Jun. 5, 2002.
(60) Provisional application No. 60/442,266, filed on Jan. 27, 2003.

(51) Int. Cl. B01D 53/56

(52) U.S. Cl. 423/235

(57) ABSTRACT

A reducing agent and a readily-oxidizable gas are injected into a NOₓ-containing process stream to reduce the concentration of the NOₓ-containing process stream by a predetermined amount.

### CROSS-REFERENCE TO RELATED APPLICATIONS

This application claims benefit of the following United States Provisional Patent Applications: S No. 60/386,560 filed Jun. 5, 2002; S No. 60/386,492 filed Jun. 5, 2002; and S No. 60/442,268 filed Jan. 24, 2003.

### FIELD OF THE INVENTION

The present invention relates to a non-catalytic process for reducing NOₓ concentrations in process streams. More particularly, the present invention relates to the injection of a reducing agent in combination with a readily-oxidizable gas to reduce NOₓ emissions in process stream effluents.

### BACKGROUND OF THE INVENTION

Increasingly stringent government regulatory emission standards have forced refiners to explore, and in some cases to implement, improved technologies for reducing the concentration of nitrogen oxides (NOₓ) in emissions from combustion and production effluent streams. For example, it is known in the art to reduce NOₓ concentrations in combustion effluent streams by the injection of ammonia, and one such patent covering this technology is U.S. Pat. No. 3,900,554 to Lyon, which is incorporated herein by reference. After this Lyon patent, there was a proliferation of patents and publications relating to the injection of ammonia into combustion effluent streams in order to reduce the concentration of NOₓ. Such patents include U.S. Pat. Nos. 4,507,269, Dean et al., and 4,115,515, Tenner et al., both of which are also incorporated herein by reference. Other patents disclose the use of ammonia injection based on the use of kinetic modeling to determine the amount of ammonia to be injected. Such patents include U.S. Pat. Nos. 4,636,370, 4,624,840, and 4,682,468, all to Dean et al., and all of which are also incorporated herein by reference. There have also been a number of patents and publications relating to the injection of urea into combustion effluent streams in order to reduce the concentration of NOₓ. One such patent covering this technology is U.S. Pat. No. 4,208,386 to Arand et al., which is incorporated herein by reference. A study by Kim and Lee (1996), incorporated herein by reference, published in the Journal of Chemical Engineering of Japan shows that urea dissociates to ammonia and cyanuric acid (HNCO) and that both of these act as reducing agents for NO in two interrelated chains of free radical reactions.

However, effluents released from process streams remain a source of NOₓ. One particularly troublesome NOₓ pollutant found in many process effluent streams is NO₂, a major irritant in smog. It is believed that NO₂ undergoes a series of reactions known as photo-chemical smog formation in the presence of sunlight and hydrocarbons.

Examples of such process streams that are a source of NOₓ include the effluent stream from the regenerator of a fluidized catalytic cracking unit (FCCU), and a carbon monoxide combustion/heat recovery unit (COHRU) used in conjunction with a FCCU. One major source of NOₓ in regenerator effluent results form the burning of carbon deposits from the spent catalyst. However, it is difficult to burn the carbon deposits from a spent catalyst without generating NOₓ in the off-gas. NOₓ produced in the regenerator and present in the off-gas is typically passed to the COHRU, which converts CO in the FCCU regenerator off-gas to CO₂ and other products such as water and/or steam. As the COHRU converts CO to CO₂ and other products, the effluent emitted into the atmosphere also contains NOₓ. It is difficult to reduce the NOₓ concentrations in these streams by thermal means, partially because of the low temperatures of these process streams. Some catalyst fines may also be present in the regenerator off-gas. The effect of catalyst fines on NOₓ reduction was demonstrated at temperatures below 850° F. in U.S. Pat. No. 4,434,147, incorporated herein by reference. The '147 patent describes a process in which ammonia and FCCU regenerator off-gas are cooled, then passed through a bed of FCCU catalyst fines created by collecting the fines on specially adapted electrostatic precipitator plates.

Hydrogen injection has been utilized in the past to enable the non-catalytic, ammonia-based, NOₓ reduction process to be more effective with lower temperature combustion effluent streams. While hydrogen injection has been used before with ammonia to reduce NOₓ in low temperature combustion streams, the amount of NOₓ released to the atmosphere is still too high for more stringent environmental regulations. Therefore, there exists a need in the art for improved methods of reducing the emission of NOₓ in refinery process streams by non-catalytic means. Thus, the inventors herein propose that a reduction in NOₓ emissions can be achieved by reducing the concentration of NOₓ in process streams such as, for example, the regenerator off-gas before it is conducted to the COHRU.

### SUMMARY OF THE INVENTION

The presently disclosed invention provides a non-catalytic process for reducing the NOₓ concentration in a NOₓ-containing process stream comprising:

a) forming a mixture of a reducing agent selected from ammonia, urea and mixtures thereof, and a readily-oxidizable gas in effective amounts that will result in the reduction of the NOₓ concentration of said NOₓ-containing process stream by a predetermined amount; and

b) injecting said mixture into said process stream at a point wherein said NOₓ-containing process stream is at a temperature below about 1600° F.

In another embodiment of the present invention, an effective amount of reducing agent and readily-oxidizable gas are injected into an existing FCC process unit regenerator overhead line at a point upstream of the FCCU's heat recovery device.

In another embodiment of the present invention, an effective amount of reducing agent and readily-oxidizable gas are simultaneously injected into an existing FCC process unit regenerator overhead line at multiple locations upstream of the FCCU's heat recovery device.

In yet another embodiment of the present invention, the readily-oxidizable gas is hydrogen and the reducing agent is ammonia.

### BRIEF DESCRIPTION OF THE FIGURES

FIG. 1 shows a plot of the data obtained as a result of the application of the present process with the injection of ammonia and hydrogen at a single location into the regenerator off-gas of a commercial fluidized catalytic cracking unit.

FIG. 2 shows a plot of the data obtained as a result of the application of the present process with injection of ammonia and hydrogen at multiple locations to the regenerator off-gas of a commercial fluidized catalytic cracking unit.

### DETAILED DESCRIPTION OF THE PRESENT INVENTION

As used herein, the reference to NOₓ, or nitrogen oxide(s) refers to the various oxides of nitrogen that may be present in process streams such as, for example, the off-gas of the regenerator of a fluidized catalytic cracking unit. Thus, the terms refer to all of the various oxides of nitrogen including nitric oxide (NO), nitrogen dioxide (NO₂), nitrous oxide (N₂O), etc. and mixtures thereof.

Mixing, as used herein when describing the mixing of the reducing agent and readily-oxidizable gas, is meant to refer to the broadest meaning given the term. Thus, mixing refers to the objective of maximizing the local contact of the reducing agent and readily-oxidizable gas with the NOₓ in the process stream at the desired molar ratios. Any suitable mixing techniques can be employed to achieve this end. These techniques include, but are not limited to, using a carrier gas with the reducing agent and/or readily-oxidizable gas to encourage more homogenous mixing; injecting a premixed stream of a reducing agent, readily-oxidizable gas and carrier gas into the process stream; or, injecting a stream of reducing agent and carrier gas and a stream of readily-oxidizable gas and carrier gas into the process stream separately.

Non-limiting examples of suitable pre-injection mixing techniques, processes or means include piping the reducing agent, readily-oxidizable gas and carrier gas through separate lines into one common vessel or into the injection line to the process stream to be treated, allowing the two reagents and the carrier to mix as they flow towards the injection point.

The present invention is a non-catalytic process that uses an effective amount of a reducing agent injected with an effective amount of a readily-oxidizable gas to reduce the NOₓ concentration of a process stream by a predetermined amount. By a predetermined amount it is meant a reduction of NOₓ by more than about 30% by volume, preferably more than about 50% by volume, and more preferably a reduction of more than about 70% by volume, based on the total volume of NOₓ present in the process stream. In a most preferred embodiment, the predetermined reduction of NOₓ is at least that amount sufficient to meet governmental regulatory emission standards.

The present process is suitable for treating any process stream containing NOₓ and greater than about 0.1 vol. % oxygen, based on the volume of the stream. Preferably the stream will contain about 0.4 to about 1.5 vol. % oxygen. The present process is especially well-suited for treating the regenerator off-gas of a fluidized catalytic cracking unit.

Fluidized catalytic cracking is an important and widely used refinery process. The catalytic cracking process typically converts heavy oils into lighter products such as gasoline. In the fluidized catalytic cracking (FCC) process, an inventory of particulate catalyst is continuously cycled between a cracking reactor and a catalyst regenerator. Average reactor temperatures are in the range of about 900-1000° F., with average feed temperatures from about 500-800° F. The reactor and the regenerator together provide the primary components of the catalytic cracking unit. FCC process units are well known in the art and U.S. Pat. No. 5,846,403, Swan, et al., incorporated herein by reference, provides a more detailed discussion of such a unit.

The regenerator is especially important to catalyst life and effectiveness because during the fluidized catalytic cracking process, carbonaceous deposits (coke) are formed on the catalyst, which substantially decrease its activity. The catalyst is then typically regenerated to regain its effectiveness by burning off at least a portion of the coke in the regenerator. This is typically done by injecting air, or another gas having a combustible amount of oxygen, into the regenerator at a rate sufficient to fluidize the spent catalyst particles. A portion of the coke contained on the catalyst particles is combusted in the regenerator, resulting in regenerated catalyst particles. Typical regenerator temperatures range from about 1050° F. to about 1450° F., while exit temperatures of the regenerator off-gas usually range from about 1200° F. to about 1500° F.

After regeneration, the catalyst particles are cycled back to the reactor. The regenerator off-gas is usually passed to further processes such as heat recovery devices, particulate removal devices, and carbon monoxide combustion/heat recovery units (COHRU), which, as previously mentioned, are designed to convert CO to CO₂ and recover available fuel energy.

Unfortunately, it is difficult to burn a substantial amount of coke from the catalyst in the regenerator without increasing the NOₓ content of the resulting off-gas. Therefore, the regenerator off-gas will typically contain nitrogen oxides (NOₓ), catalyst fines, sulfur oxides (SOₓ), carbon dioxide, carbon monoxide, and other compounds formed during the combustion of at least a portion of the coke from the catalyst particles. Of the nitrogen oxides present in the regenerator off-gas, nitric oxide (NO) typically makes up the majority of all NOₓ present. NO will usually represent about 90% in the regenerator off-gas. Therefore, the presently claimed process is especially concerned with the reduction and control of NO.

It is preferred to operate the regenerator in full burn mode to burn coke from the catalyst. During full-burn mode, the regenerator off-gas composition is generally about 0.6-1.5 vol. % oxygen, about 15-20 vol. % water, about 50 to about 200 parts per million by volume (vppm) NO, about 20-50 vppm CO, about 500-1000 vppm SO₂ with the balance being N₂ and CO₂.

Concentrations of NOₓ in process streams can be reduced by up to about 90% by volume or more through the use of the present non-catalytic NOₓ reduction process. This is well within the desired reduction range described above. The only commercially available technology to achieve such a level of reduction is technology based on the use of a catalytic process, which is significantly more expensive when compared to the present non-catalytic process.

The present invention, however, achieves NOₓ reductions in low temperature process streams comparable to those achieved through catalytic processes by the injection of a reducing agent. The process streams treated with the presently claimed process also typically have low concentrations of oxygen, necessitating the use of a readily-oxidizable gas being injected with the reducing agent.

Reducing agents suitable for use in the presently claimed invention include urea, ammonia, and mixtures thereof. The preferred reducing agent is ammonia. Readily-oxidizable gases suited for use in the present process include paraffinic, olefinic and aromatic hydrocarbons and mixtures thereof such as, for example, gasoline and fuel oil, oxygenated hydrocarbons including formic and oxalic acids, nitrogenated hydrocarbons, sulfonated hydrocarbons, carbon monoxide, and hydrogen. Hydrogen is the preferred readily-oxidizable gas since it is not itself an air pollutant and cannot yield an air pollutant by incomplete oxidation.

By injection, it is meant that the mixture of the readily-oxidizable gas and reducing agent is conducted or introduced into the NOₓ containing process stream to be treated. The injection of the reducing agent and readily-oxidizable gas can be by any suitable means known in the art. The injection means chosen is not critical to the present invention as long as it is one that effectively introduces the reducing agent and readily-oxidizable gas into the process stream.

An effective amount of reducing agent used herein is based on the amount of NOₓ that is to be reduced. The amount of reducing agent used will typically range from about 0.5-12 moles of reducing agent per mole of NOₓ, preferably about 0.5-8 moles of reducing agent per mole of NOₓ. It is more preferred to use about 1-4 moles of reducing agent per mole of NOₓ. The measurement of the concentration of NOₓ in the regenerator off-gases may be achieved by any suitable method known in the art, and the method chosen is not critical to the process presently claimed.

It is believed that a complex chain of free radical reactions achieves the non-catalytic reduction of NOₓ with the present reducing agent and readily-oxidizable gas. Not wanting to be limited by theory, the inventors herein believe the overall effect can be illustrated by the following two competing reactions:

NO+NH₃+O₂→N₂+H₂O (reduction) Equation 1

NH₃+O₂→NO+H₂O (oxidation) Equation 2

The use of urea as the reducing agent introduces cyanuric acid (HNCO) as well as ammonia to the process. As demonstrated in the work of Lee and Kim (1996), cyanuric acid acts as a reducing agent for NO and also interacts with the NO—NH₃—O₂ chemistry summarized in Equations 1 and 2. Although the cyanuric acid reduction process is not thoroughly understood, and not wishing to be limited by theory, the inventors hereof believe that the dissociation of one mole of urea liberates one mole of ammonia and one mole of cyanuric acid. Experimental data from the Kim and Lee study (1996) suggests that cyanuric acid stoichiometrically reduces NO to elemental nitrogen and water at a molar ratio with NO of 1:1. Thus, urea should generally be used at a molar ratio to NO that is roughly one half the effective molar ratio for ammonia.

The reduction reaction of Equation 1 dominates in the 1600° F-2000° F. temperature range. Above 2000° F., the reaction of Equation 2 becomes more prevalent. Thus, in the practice of the present invention, it is desirable to operate at temperatures below about 2000° F. However, operating temperatures lower than about 1600° F. are achievable with the reduction reaction still being dominated by Equation 1 through the use of the present invention. The inventors hereof have unexpectedly found that, at temperatures below about 1600° F., the reduction reaction of Equation 1 will not effectively reduce NOₓ without the injection of a readily-oxidizable gas, such as hydrogen. It should be noted that as the temperature of the process stream decreases, the amount of readily-oxidizable gas needed to drive the reduction reaction increases. However, the inventors herein have determined that the molar ratios of readily-oxidizable gas disclosed herein can be used at an effective operating temperature range below about 1600° F., even below about 1300° F., with the reduction reaction still being dominated by Equation 1. This makes the present invention especially suited for reducing NOₓ concentrations in the off-gas of an FCCU regenerator because the temperature of the regenerator off-gas stream is typically low, below about 1600° F. It should be noted, however, that the present invention can also effectively operate over any temperature range between about 1200° F. to about 1600° F.

A readily-oxidizable gas is used to drive the NOₓ reduction reaction. An effective amount of readily-oxidizable gas is that amount that enables the reducing agents of the present invention to effectively reduce the NOx concentration by the predetermined amount. A molar ratio of about 1:1 to about 50:1 moles of readily-oxidizable gas per mole of reducing agent is considered an effective amount of readily-oxidizable gas, preferably greater than about 10:1 to about 40:1, more preferably about 11:1 to about 40:1, and most preferably about 15:1 to about 30:1. The actual mole ratio employed will be dependent on such things as the temperature of the process stream; the composition of the process stream; the effectiveness of the injection means used for mixing the readily-oxidizable gas with the carrier gas, the reducing agent and the NOₓ-carrying stream; and the reducing agent utilized. Thus, for a given process stream, the most effective readily-oxidizable gas to reducing agent molar ratio will be in the 1:1 to 50:1 range. The injection of readily-oxidizable gas at rates yielding readily-oxidizable gas to reducing agent molar ratios greater than 10:1 is, in part, made necessary by the low oxygen concentration found in process streams such as the regenerator off-gas. For example, such streams typically contain less than about 1.5% by volume of O₂. It should be noted that the regenerator off-gas is termed a process stream instead of a combustion stream because of the low oxygen concentrations. Combustion streams typically contain greater than 1.5 vol. % oxygen.

Since the amount of readily-oxidizable gas and reducing agent used are typically a small percentage of the regenerator off-gas flow, typically less than about 0.5% by volume, based on the volume of the stream, it is preferred to use only an effective amount of a readily available and relatively inexpensive carrier material. Non-limiting examples of carrier materials include air and steam; however, any carrier material that does not have a deleterious effect on NOₓ reduction, or which itself contributes to undesirable emissions, can be used. Thus, it is contemplated to mix effective amounts of reducing agent and/or readily-oxidizable gas prior to mixing with a carrier material, or within the line that contains the carrier material. It is preferred that the reducing agent/readily-oxidizable gas mixture be injected into the line that conducts the carrier material.

By an effective amount of carrier material, it is meant an amount of carrier material that will adequately mix the reducing agent and the readily-oxidizable gas with the process stream, i.e., maximize the contact of the two reagents with the NOₓ sought to be reduced.

As previously stated, the regenerator off-gas also typically contains catalyst fines. These catalyst particles may be removed from the regenerator off-gas by any suitable means known in the art. However, the presence of catalyst fines in the regenerator off-gas is believed to assist the NOₓ reduction reaction. Thus, the presence of some catalyst fines, although not necessary for the practice of the instarit invention, is preferred to assist the NOₓ reduction reaction and reduce the amount of readily oxidizable gas that is needed.

In one embodiment of the present invention, effective amounts of a reducing agent and a readily-oxidizable gas, preferably with an effective amount of carrier material, are injected directly into the regenerator's existing overhead line. Thus, the existing overhead line functions as the reaction zone for the NOₓ reduction reaction, thereby eliminating the need to add costly processing equipment to effectuate the present process. The injection mixture is preferably injected at a point between the COHRU and the regenerator. It is preferred that the injection occur as near the regenerator off-gas outlet as possible so that the higher temperatures near the regenerator outlet can be utilized, thereby reducing the amount of readily-oxidizable gas needed for a desired level of NOₓ reduction. It is also advantageous to maximize the residence time of the reducing agent and readily-oxidizable gas in the NOₓ reduction reaction.

In another embodiment, at least two, preferably a plurality of, injection points are used along the regenerator overhead line. Effective amounts of a reducing agent and a readily oxidizable gas, preferably with an effective amount of carrier material, are injected through these multiple injection points, which will typically be between the COHRU and the regenerator. Preferably all injections occur simultaneously. Thus, the existing regenerator overhead line again functions as the reaction zone for the NOₓ reduction reaction, thereby eliminating the need to add costly processing equipment to effectuate the present process. Preferably, the simultaneous injections occur as near the regenerator off-gas outlet as possible. However, the multiple injection locations are also preferably spaced such that the appropriate residence time between locations is achieved such that the desired effect from the use of multiple injection locations is realized. As previously mentioned, it is advantageous to maximize the residence time of the reducing agent and readily-oxidizable gas in the overhead line to complete the reaction.

The above description is directed to several preferred means for carrying out the present invention. Those skilled in the art will recognize that other means, which are equally effective, could be devised for carrying out the spirit of this invention.

### EXAMPLES

The following examples will illustrate the effectiveness of the present process, but are not meant to limit the present invention.

### Example 1

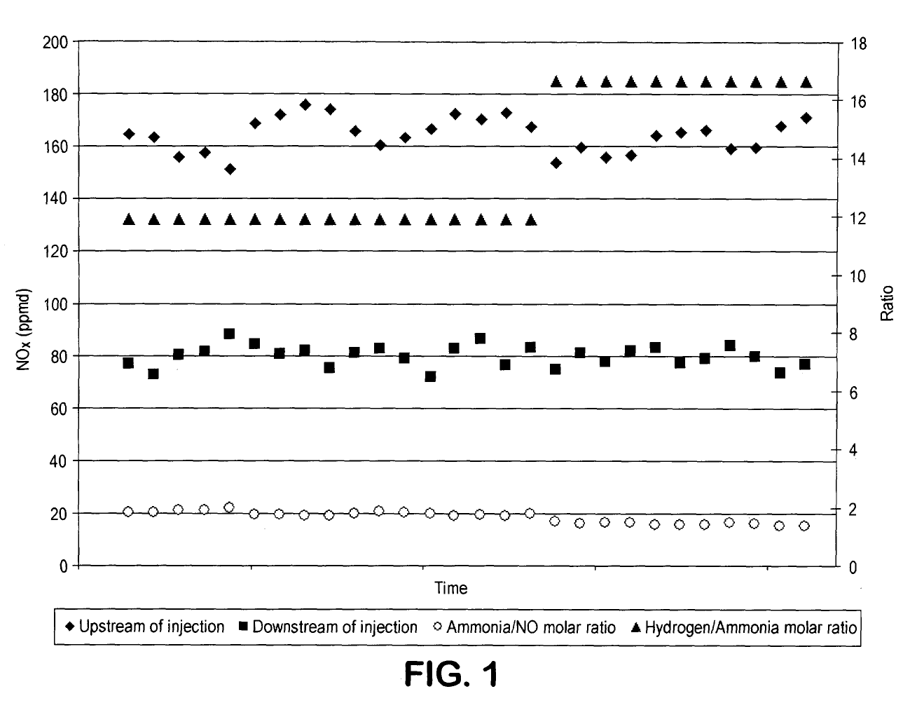

The present NOₓ reducing process was tested at a commercial FCCU, and the results are shown in FIG. 1 hereof. Initial tests show that the injection of ammonia and hydrogen in a non-catalytic environment can be effective to reduce the NOₓ concentration by up to about 50% by volume. However, NOₓ reductions of up to 90% can theoretically be achieved.

Off-gas from a commercial FCCU regenerator was tested to determine its chemical composition. These tests revealed that the composition of the regenerator off-gas as tested was approximately 0.8% O₂ by volume, 18% H₂O by volume, 165 vppm NO, 700 vppm SO₂ and 25 vppm CO with the balance being N₂ and CO₂. The temperature of the off-gas at the injection point was approximately 1330° F. Ammonia and hydrogen were injected with steam in various ratios at a point as close to the outlet of the regenerator as was practical. The reduction in the concentration of NOₓ was then measured. The results of this experiment can be seen in FIG. 1. The reduction in NOₓ of 55% by volume was achieved with a NH₃:NO volume ratio of approximately 1.5, and a H₂:NH₃ volume ratio of 15.

### Example 2

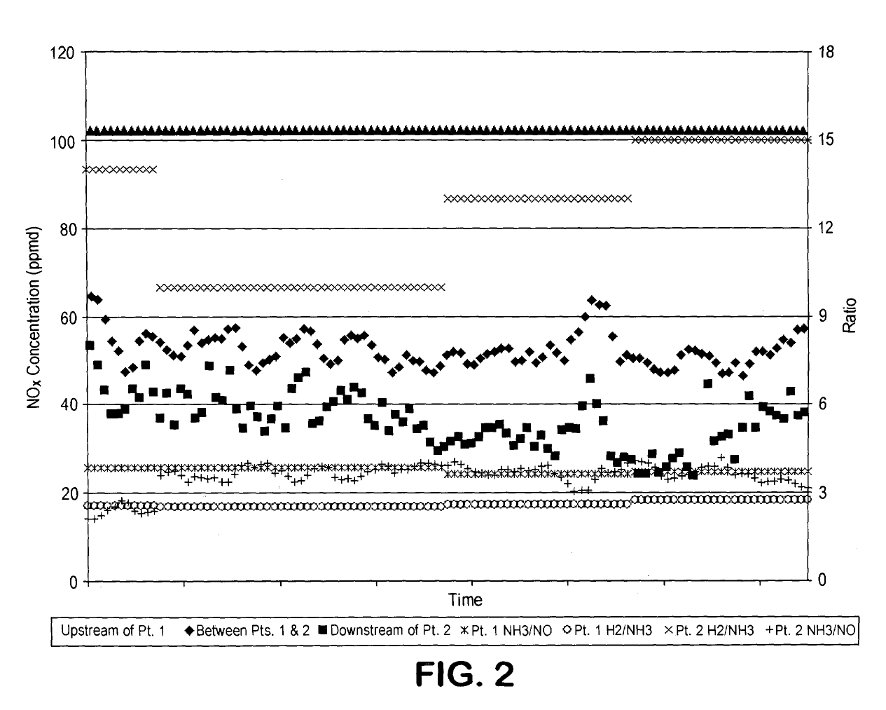

The present NOₓ reducing process was tested in a commercial FCCU, with ammonia and hydrogen injected at two locations. The results are shown in FIG. 2 hereof. Initial tests show that the injection of ammonia and hydrogen at multiple locations in a non-catalytic environment can be effective to reduce the NOₓ concentration by up to about 60% by volume. However, NOₓ reductions of up to 90% can theoretically be achieved. Off-gas from a commercial FCCU regenerator was tested to determine its chemical composition. These tests revealed that the composition of the regenerator off-gas as tested was approximately 0.8% O₂ by volume, 18% H₂O by volume, 100 vppm NO, 700 vppm SO₂ and 25 vppm CO with the balance being N₂ and CO₂. The temperature of the off-gas at the injection point was approximately 1370° F. Ammonia and hydrogen were injected with steam in various ratios at a point as close to the outlet of the regenerator off-gas as was practical and at a second point approximately one second downstream of the first injection point in terms of residence time. The reduction in the concentration of NOₓ was then measured. The NOₓ upstream of the first injection point was estimated by averaging the NOₓ measured in the regenerator overhead line when no ammonia or hydrogen was injected. The results of this experiment can be seen in FIG. 2. The reduction in NOₓ of 60% by volume was achieved with a NH₃:NO volume ratio of approximately 3.5 at both injection points, and a H₂:NH₃ volume ratio of 3 at the first injection point and 15 at the second point. It is believed that the low H₂:NH3 utilized at the first injection point during this test is effective at such a low temperature (1370° F.) due to a significant promotion of the NOₓ reduction reaction by the high concentration of catalyst fines at the regenerator outlet.

1. A non-catalytic process for reducing the NOₓ concentration in an NOₓ-containing process stream comprising:
a) forming a mixture of a reducing agent selected from ammonia, urea and mixtures thereof, and a readily-oxidizable gas in effective amounts that will result in the reduction of the NOₓ concentration of said NOₓ-containing process stream by a predetermined amount; and
b) injecting said mixture into said process stream at a point wherein said NOₓ-containing process stream is at a temperature below about 1600° F.

2. The process of claim 1 wherein said readily-oxidizable gas is selected from the group consisting of paraffinic, olefinic and aromatic hydrocarbons and mixtures thereof, gasoline, fuel oil, oxygenated hydrocarbons, formic and oxalic acids, nitrogenated hydrocarbons, sulfonated hydrocarbons, carbon monoxide, and hydrogen.

3. The process according to claim 2 wherein said readily-oxidizable gas is hydrogen.

4. The process according to claim 3 wherein said reducing agent is ammonia.

5. The process according to claim 4 wherein said process stream has an oxygen concentration of more than about 0.1% by volume, based on the process stream.

6. The process according to claim 4 wherein said process stream has an oxygen concentration of about 0.4 to about 1.5% by volume, based on the process stream.

7. The process according to claim 6 wherein said process stream is the regenerator off-gas stream of a fluidized catalytic cracking unit.

8. The process according to claim 7 wherein said reducing agent is injected in a molar ratio of about 0.5 to about 12 moles per mole of NOₓ.

9. The process according to claim 8 wherein said reducing agent is injected in a molar ratio of about 0.5 to about 8 moles per mole of NOₓ.

10. The process according to claim 9 wherein said reducing agent is injected in a molar ratio of about 1 to about 4 moles per mole of NOₓ.

11. The process according to claim 10 wherein said mixture comprises said readily-oxidizable gas and said reducing agent in a molar ratio of about 1:1 to about 50:1 moles of readily-oxidizable gas per mole of reducing agent.

12. The process according to claim 11 wherein said mixture comprises said readily-oxidizable gas and said reducing agent in a molar ratio of about 10:1 to about 40:1 moles of readily-oxidizable gas per mole of reducing agent.

13. The process according to claim 12 wherein said mixture comprises said readily-oxidizable gas and said reducing agent in a molar ratio of about 15:1 to about 30:1 moles of readily-oxidizable gas per mole of reducing agent.

14. The process according to claim 13 wherein said reducing agent and readily-oxidizable gas are injected with a carrier material such as steam or air.

15. The process according to claim 14 wherein catalyst fines from the regenerator are present in the regenerator off-gas.

16. The process according to claim 15 wherein said mixture is injected into said regenerator off-gas at a point between the regenerator and a carbon monoxide combustion/heat recovery unit (COHRU).

17. The process according to claim 16 wherein said mixture is injected into said regenerator off-gas at a point where the regenerator off-gas is at a temperature below about 1300° F.

18. The process according to claim 17 wherein said mixture is injected into said regenerator off-gas at a point where the regenerator off-gas is at a temperature in the range of about 1200° F. to about 1600° F.

19. The process of claim 1 wherein said predetermined amount is a reduction of NOₓ in said process stream by more than about 30 vol. %.

20. The process of claim 19 wherein said predetermined amount is a reduction of NOₓ in said process stream by more than about 70 vol. %.

21. The process according to claim 20 wherein said predetermined amount is a reduction of NOₓ in said process stream by about 90 vol. %.

22. A non-catalytic process for reducing the NOₓ concentration in the effluent of a process stream comprising:
a) forming a mixture of a reducing agent selected from ammonia, urea and mixtures thereof, and a readily-oxidizable gas in effective amounts that will result in the reduction of the NOₓ concentration of said NOₓ-containing process stream by a predetermined amount; and
b) injecting said mixture into said process stream through at least two injection points wherein said NOₓ-containing process stream is at a temperature below about 1600° F.

23. The process according to claim 22 wherein said mixture is injected through said at least two injection points simultaneously.

24. The process according to claim 23 wherein said mixture is injected into said process stream through a plurality of injection points.

25. A non-catalytic process for reducing the NOₓ concentration in a process stream comprising:
a) forming a mixture of a carrier material, ammonia, and hydrogen gas in a ratio of about 1-4 moles of ammonia per mole of NOₓ and about 15:1 to about 30:1 moles of hydrogen per mole of ammonia; and
b) injecting said mixture into said process stream through at least two injection points wherein said NOₓ-containing process stream is at a temperature between about 1200° F. and about 1600° F.

26. The process according to claim 25 wherein said mixture is injected through at least two injection points simultaneously.

27. The process according to claim 26 wherein said mixture is injected into said process stream through a plurality of injection points simultaneously.
